(19) United States
(12) Patent Application Publication
(10) Pub. No.: US 2025/0334486 A1
(43) Pub. Date: Oct. 30, 2025

(54) INFORMATION PROCESSING APPARATUS AND OPERATING METHOD OF INFORMATION PROCESSING APPARATUS

(71) Applicant: TOYOTA JIDOSHA KABUSHIKI KAISHA, Toyota-shi (JP)

(72) Inventors: Liang GONG, Tokyo-to (JP); Yuta OKABE, Tokyo-to (JP); Shingo NIIYAMA, Tokyo-to (JP); Ryuichi DANNO, Kasugai-shi (JP)

(21) Appl. No.: 19/098,318

(22) Filed: Apr. 2, 2025

(30) Foreign Application Priority Data
Apr. 25, 2024 (JP) 2024-071925

(51) Int. Cl. G01M 17/007

(52) U.S. Cl. CPC G01M 17/007

(57) ABSTRACT

An information processing apparatus includes an acquisition interface configured to acquire sorting information for sorting out, among a plurality of equipment of a vehicle for a test drive, first equipment of interest to a user from other second equipment, and a controller configured to output first question information on the first equipment, the first question information including more questions than second question information on the second equipment or a question with more characters than a question included in the second question information.

### CROSS-REFERENCE TO RELATED APPLICATION

This application claims priority to Japanese Patent Application No. 2024-071925, filed on Apr. 25, 2024, the entire contents of which are incorporated herein by reference.

### TECHNICAL FIELD

The present disclosure relates to an information processing apparatus and an operating method of an information processing apparatus.

### BACKGROUND

In the development and sales of vehicles, the feedback and other reactions of users who have test-driven vehicles are used to improve products. Various technologies have been proposed to support the collection of such responses from users. For example, Patent Literature (PTL) 1 discloses technology for distributing questionnaires to vehicle users.

### CITATION LIST

### Patent Literature

PTL 1: JP 2010-277583 A

### SUMMARY

There is room to more effectively collect responses from users who have test-driven vehicles.

The following discloses an information processing apparatus and the like that enable more effective response collection from users who have test-driven vehicles.

An information processing apparatus in the present disclosure includes:
an acquisition interface configured to acquire sorting information for sorting out, among a plurality of equipment of a vehicle for a test drive, first equipment of interest to a user from other second equipment; and
a controller configured to output first question information on the first equipment, the first question information including more questions than second question information on the second equipment or a question with more characters than a question included in the second question information.

An operating method of an information processing apparatus in the present disclosure includes:
acquiring sorting information for sorting out, among a plurality of equipment of a vehicle for a test drive, first equipment of interest to a user from other second equipment; and
outputting first question information on the first equipment, the first question information including more questions than second question information on the second equipment or a question with more characters than a question included in the second question information.

According to the information processing apparatus and the like in the present disclosure, it is possible to more effectively collect responses from users who have test-driven vehicles.

### BRIEF DESCRIPTION OF THE DRAWINGS

In the accompanying drawings:

FIG. 1 is a diagram illustrating an example configuration of an information communication system;

FIG. 2 is a diagram schematically illustrating a question DB; and

FIG. 3 is a sequence diagram illustrating an example operation procedure of the information communication system.

### DETAILED DESCRIPTION

An embodiment will be described below.

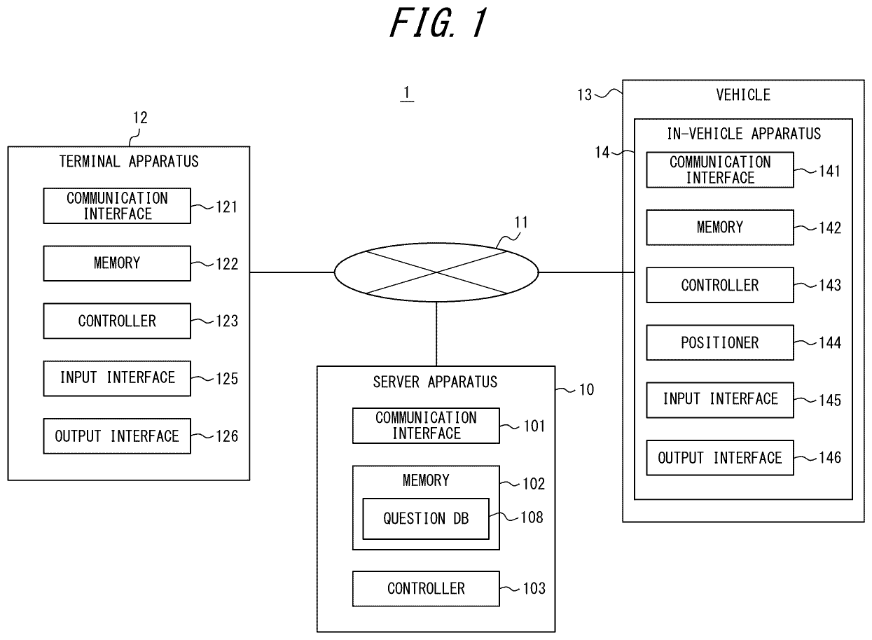

FIG. 1 is a diagram illustrating an example of a configuration of an information processing system 1 according to the embodiment. The information processing system 1 includes at least one server apparatus 10, at least one terminal apparatus 12, and at least one in-vehicle apparatus 14 mounted in a vehicle 13 that are communicably connected to each other via a network 11. The server apparatus 10 is, for example, a server computer that belongs to a cloud computing system or another computing system and functions as a server that implements various functions. The terminal apparatus 12 is an information processing terminal used by car dealership sales staff who offer vehicles 13 for test drives, and exchanges various information with the server apparatus 10. The terminal apparatus 12 is, for example, a personal computer, a tablet terminal apparatus, or the like. The vehicle 13 is, for example, a passenger car or commercial vehicle, which is offered for test drive for sales or monitoring purposes. The in-vehicle apparatus 14 has communication and information processing functions, for example, a navigation system. The network 11 may, for example, be the Internet or may include an ad hoc network, a local area network (LAN), a metropolitan area network (MAN), other networks, or any combination thereof.

In the present embodiment, the server apparatus 10 as an “information processing apparatus” acquires sorting information for sorting out, among a plurality of equipment of the vehicle 13 for a test drive, equipment of interest to a user (hereinafter referred to as “target equipment”) from other equipment (hereinafter referred to as “other equipment”), and outputs question information on the target equipment (hereinafter referred to as “focused question information”). The focused question information includes more questions than question information on other equipment (hereinafter referred to as “normal question information”) or questions with more characters than questions included in the normal question information. The equipment of the vehicle 13 includes equipment related to the driving support of the vehicle 13, such as navigation systems, and equipment related to the interior environment and entertainment of the vehicle 13, such as multimedia, air conditioning, sound, and lighting. Equipment may include equipment related to the operation of the vehicle 13, such as gas pedal, brake, steering, etc. The focused question information is transmitted, for example, from the server apparatus 10 to the terminal apparatus 12, where the questions are presented to the user and the answers are collected. According to such an embodiment, even when the degree of interest of the user differs depending on the equipment, it is possible to more effectively collect responses from users who have test-driven the vehicle 13 than by asking the same questions for all equipment, by conducting a more detailed answer hearing for the target equipment in which the user is particularly interested.

### <Configuration of Server Apparatus 10>

The server apparatus 10 includes a communication interface 101, a memory 102, and a controller 103. The server apparatus 10 is, for example, a single computer. The server apparatus 10 may be two or more computers that are communicably connected to each other and operate in cooperation. In this case, the configuration illustrated in FIG. 1 can be arranged among two or more computers as appropriate.

The communication interface 101 includes one or more interfaces for communication. The interfaces for communication include, for example, a LAN interface. The communication interface 101 receives information to be used for operations of the server apparatus 10 and transmits information obtained by the operations of the server apparatus 10. The server apparatus 10 is connected to the network 11 by the communication interface 101 and communicates information with the terminal apparatus 12 and the vehicle 13 via the network 11. In the server apparatus 10, the communication interface 101 acquires information on the number of times the operation has been performed by the user on equipment of the vehicle 13 from the in-vehicle apparatus 14 as a “communication interface”.

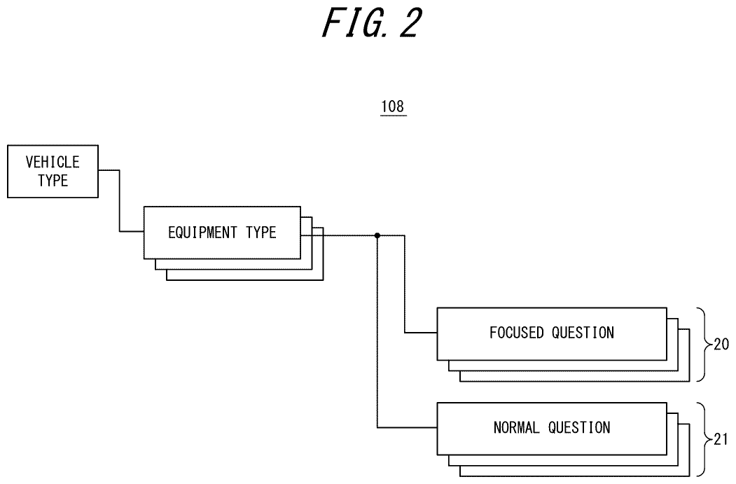

The memory 102 includes, for example, one or more semiconductor memories, one or more magnetic memories, one or more optical memories, or a combination of at least two of these types, to function as main memory, auxiliary memory, or cache memory. The semiconductor memories are, for example, Random Access Memory (RAM) or Read Only Memory (ROM). The RAM is, for example, Static RAM (SRAM) or Dynamic RAM (DRAM). The ROM is, for example, Electrically Erasable Programmable ROM (EEPROM). The memory 102 stores information to be used for the operations of the server apparatus 10 and information obtained by the operations of the server apparatus 10. For example, the memory 102 stores a question database (DB) 108 corresponding to the equipment of interest in the vehicle 13. The question DB 108 includes one or more equipment types for each vehicle type and a focused question set 20 and a normal question set 21 corresponding to each of the equipment types, as illustrated schematically in FIG. 2. Equipment type indicates the type of navigation system, multimedia, air conditioning, sound, lighting and entertainment equipment, accelerator, brake, steering wheel, etc. The focused question set 20 includes one or more focused questions, and the normal question set 21 includes fewer normal questions than the corresponding focused questions in the focused question set 20. The focused questions and the normal questions are designed to ask the user about his or her feeling about the corresponding equipment. In addition, the focused questions included in the focused question set 20 are more detailed questions than the normal questions included in the normal question set 21. Specifically, the representative value of the number of characters for the focused questions included in the focused question set 20 is greater than the representative value of the number of characters for the normal questions included in the normal question set 21. The representative value of the number of characters is, for example, the mean or median.

Returning to FIG. 1, the controller 103 includes one or more processors, one or more dedicated circuits, or a combination thereof. The processors are general purpose processors, such as central processing units (CPUs), or dedicated processors, such as graphics processing units (GPUs), specialized for particular processes. The dedicated circuits are, for example, field-programmable gate arrays (FPGAs), application specific integrated circuits (ASICs), or the like. The controller 103 executes information processing related to the operations of the server apparatus 10 while controlling the components of the server apparatus 10.

The functions of the server apparatus 10 are realized by execution of a control program by a processor included in the controller 103. The control program is a program for causing a computer to execute the processing of steps included in the operations of the server apparatus 10, thereby enabling the computer to realize the functions corresponding to the processing of the steps. That is, the control program is a program for causing a computer to function as the server apparatus 10. Some or all of the functions of the server apparatus 10 may be realized by a dedicated circuit included in the controller 103. The control program may be stored on a non-transitory recording/storage medium readable by the server apparatus 10, and be read from the medium by the server apparatus 10.

### <Configuration of Terminal Apparatus 12>

The terminal apparatus 12 includes a communication interface 121, a memory 122, a controller 123, an input interface 125, and an output interface 126.

The communication interface 121 includes a communication module compliant with a wired or wireless LAN standard, a module compliant with a mobile communication standard such as Long Term Evolution (LTE), 4th Generation (4G), or 5th Generation (5G), or the like. The terminal apparatus 12 connects to the network 11 via a nearby router apparatus or mobile communication base station using the communication interface 121, and communicates information with other apparatuses over the network 11.

The memory 122 includes one or more semiconductor memories, one or more magnetic memories, one or more optical memories, or a combination of at least two of these types. The semiconductor memories are, for example, RAM or ROM. The RAM is, for example, SRAM or DRAM. The ROM is, for example, EEPROM. The memory 122 functions as, for example, a main memory, an auxiliary memory, or a cache memory. The memory 122 stores information to be used for operations of the controller 123 and information obtained by the operations of the controller 123.

The controller 123 has one or more general purpose processors such as CPUs or micro processing units (MPUs) or one or more dedicated processors that are dedicated to specific processing. Alternatively, the controller 123 may have one or more dedicated circuits such as FPGAs or ASICs. The controller 123 is configured to perform overall control of operations of the terminal apparatus 12 by operating according to control/processing programs or operating according to operating procedures implemented in the form of circuits. The controller 123 then transmits and receives various types of information to and from the server apparatus 10 and the like via the communication interface 121, to execute operations according to the present embodiment.

The input interface 125 includes one or more interfaces for input. The interface for input includes, for example, a physical key, a capacitive key, a pointing device, a touch screen integrally provided with the display, a camera that captures images or image codes, or an IC card reader. The interface for input may also include a microphone that accepts audio input. The input interface 125 accepts input of information to be used in the operations of the controller 123 and transmits the input information to the controller 123.

The output interface 126 includes one or more interfaces for output. The interfaces for output include, for example, a display or a speaker. The display is, for example, a liquid crystal display (LCD) or an organic electro-luminescent (EL) display. The output interface 126 outputs information obtained by the operations of the controller 123.

The functions of the controller 123 are realized by execution of a control program by a processor included in the controller 123. The control program is a program for causing the processor to function as the controller 123. Some or all of the functions of the controller 123 may be realized by a dedicated circuit included in the controller 123.

### <Example Configuration of In-Vehicle Apparatus 14>

The in-vehicle apparatus 14 includes a communication interface 141, a memory 142, a controller 143, a positioner 144, an input interface 145, and an output interface 146. These components may be configured as a single control apparatus, as two or more control apparatuses, or with another apparatus such as a control apparatus and a communication device. The control apparatus includes an electronic control unit (ECU), for example. The communication device includes a data communication module (DCM), for example. The components are communicably connected to each other or to equipment in the vehicle 13, by an in-vehicle network compliant with a standard such as a controller area network (CAN).

The memory 142, the controller 143, the input interface 145, and the output interface 146 have configurations equivalent to those of the memory 122, the controller 123, the input interface 125, and the output interface 126 of the terminal apparatus 12, respectively.

The communication interface 141 includes one or more interfaces for communication. Examples of the interface for communication include an interface corresponding to mobile communication standards, such as LTE, 4G, or 5G. The communication interface 141 receives information to be used for operations of the controller 143, and transmits information obtained by the operations of the controller 143. The controller 143 connects to the network 11 using the communication interface 141 through a mobile communication base station, and communicates information with other apparatuses via the network 11.

The positioner 144 includes one or more Global Navigation Satellite System (GNSS) receivers. The GNSS includes, for example, Global Positioning System (GPS), Quasi-Zenith Satellite System (QZSS), BeiDou, Global Navigation Satellite System (GLONASS), and/or Galileo. Based on information acquired by the positioner 144, positional information for the vehicle 13 is obtained.

The controller 143 controls each of the communication interface 141, the memory 142, the positioner 144, the input interface 145, and the output interface 146 while exchanging various information with these components and also controls the operation of the vehicle 13. At the time of travel of the vehicle 13, the controller 143 controls the operation of the vehicle 13 by presenting various information necessary for the operation to the driver via the output interface 146 and/or by controlling the automatic operation of the vehicle 13.

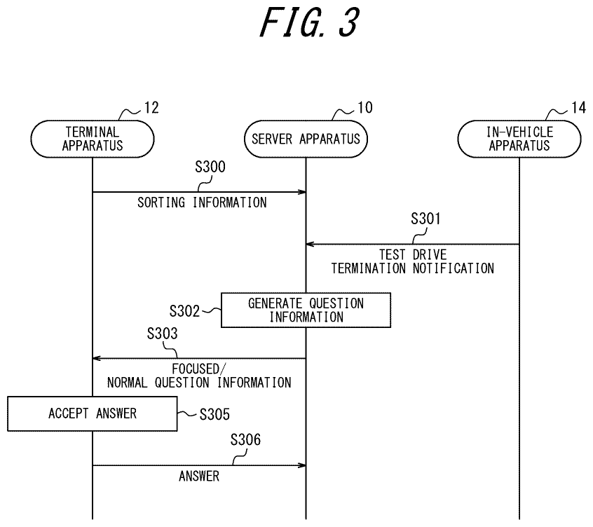

FIG. 3 is a sequence diagram illustrating an operating procedure of the information processing system 1 according to the present embodiment. FIG. 3 illustrates the steps in the coordinated operation of the server apparatus 10, the terminal apparatus 12, and the in-vehicle apparatus 14. The steps pertaining to the various types of information processing by the server apparatus 10, the terminal apparatus 12, and the in-vehicle apparatus 14 in FIG. 3 are performed by the respective controllers 103, 123, and 143. The steps pertaining to transmission and reception of various types of information to and from the server apparatus 10, the terminal apparatus 12, and the in-vehicle apparatus 14 are performed by the respective controllers 103, 123, and 143 transmitting and receiving information to and from each other via the respective communication interfaces 101, 121, and 141. In the server apparatus 10, the terminal apparatus 12, and the in-vehicle apparatus 14, the respective controllers 103, 123, and 143 appropriately store the information that is transmitted and received in the respective memories 102, 122, and 142. Furthermore, the controllers 123 and 143 of the terminal apparatus 12 and the in-vehicle apparatus 14 accept input of various information from the user by the respective input interfaces 125 and 145, and output various information to the user by the respective output interfaces 126 and 146.

In S300, the terminal apparatus 12 transmits sorting information to the server apparatus 10. The sorting information includes the results of the selection of the target equipment. For example, when a user starts a test drive of a vehicle 13, if the target equipment is selected and input to the terminal apparatus 12 by the user or a car dealer representative, the terminal apparatus 12 transmits the selection result of the target equipment to the server apparatus 10. In this case, information on the type of the vehicle 13 is first input to the terminal apparatus 12, the terminal apparatus 12 transmits the information on the type of vehicle to the server apparatus 10, and the server apparatus 10 may extract the equipment type corresponding to the type of vehicle from the question DB 108 and transmit the information on the equipment type to the terminal apparatus 12. Then, the terminal apparatus 12 presents the equipment type according to the vehicle type to the user or person in charge, and the user or person in charge can select the target equipment from the presented equipment types. For example, when one or more of the navigation system, multimedia, air conditioning, sound, lighting and entertainment equipment, accelerator, brake, steering, etc. are selected as target equipment and entered into the terminal apparatus 12, the terminal apparatus 12 transmits the entered information to the server apparatus 10. The terminal apparatus 12 can, for example, display images of the exterior or interior of the vehicle 13 and allow the user to select various equipment by tapping, pinching out, or other operations.

When the test drive of the vehicle 13 is terminated, in S301, the in-vehicle apparatus 14 transmits a test drive termination notification to the server apparatus 10. For example, when the user terminates the test drive on the desired course, information indicating the termination of the test drive is input to the in-vehicle apparatus 14. In response, the in-vehicle apparatus 14 transmits a test drive termination notification to the server apparatus 10.

In S306, the server apparatus 10 generates question information. The server apparatus 10 generates focused question information with respect to the selected target equipment. The server apparatus 10 extracts the focused questions from the focused question set 20 corresponding to the selected target equipment and generates focused question information including the focused questions. In addition to the focused question information, the server apparatus 10 may also generate normal question information with respect to other equipment that was not selected. The server apparatus 10 extracts the normal questions from the normal question set 21 corresponding to the other equipment and generates normal question information including the extracted normal questions. Generation or non-generation of normal question information can be instructed in advance to the server apparatus 10 from the terminal apparatus 12 by a person in charge of the car dealership or other person.

In S303, the server apparatus 10 transmits the focused question information or the focused question information and normal question information to the terminal apparatus 12.

In S305, the terminal apparatus 12 accepts answers to the focused question information or answers to the priority and normal question information. The terminal apparatus 12 outputs each question and accepts user input of answers to each question. Users can answer each question based on their impressions after the test drive.

In S309, the terminal apparatus 12 transmits information on the answers to the focused question information or the answers to the focused question information and normal question information to the server apparatus 10. The server apparatus 10 stores the answers tied to the questions for each piece of equipment.

The answers collected in this procedure are acquired from the server apparatus 10 by the terminal apparatus 12 or other devices as appropriate, and are used to develop and improve the equipment of the vehicle 13. In particular, it will be possible to collect more detailed user responses about the target equipment.

In the embodiments described above, some or all of the operations of the server apparatus 10 may be performed by either or both of the terminal apparatus 12 and the in-vehicle apparatus 14. In such a case, the server apparatus 10 and either or both of the terminal apparatus 12 and the in-vehicle apparatus 14, or the combination of the terminal apparatus 12 and the in-vehicle apparatus 14, or each alone, constitute the “information processing apparatus”. In the terminal apparatus 12 or the in-vehicle apparatus 14, the communication interface 121 or the communication interface 141, or the input interface 125 or the input interface 145, respectively, may function as an “acquisition interface”.

According to the embodiment described above, it is possible to more effectively collect responses from the user who has test-driven the vehicle 13.

While the embodiment has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. An information processing apparatus comprising:
an acquisition interface configured to acquire sorting information for sorting out, among a plurality of equipment of a vehicle for a test drive, first equipment of interest to a user from other second equipment; and
a controller configured to output first question information on the first equipment, the first question information including more questions than second question information on the second equipment or a question with more characters than a question included in the second question information.

2. The information processing apparatus according to claim 1, wherein the controller is configured to further output the second question information.

3. The information processing apparatus according to claim 1, wherein a predetermined operation is performed on information regarding the first equipment output by a terminal apparatus and the acquisition interface is configured to thereby acquire the sorting information.

4. An operating method of an information processing apparatus comprising:
acquiring sorting information for sorting out, among a plurality of equipment of a vehicle for a test drive, first equipment of interest to a user from other second equipment; and
outputting first question information on the first equipment, the first question information including more questions than second question information on the second equipment or a question with more characters than a question included in the second question information.
